(19) United States
(12) Patent Application Publication
(10) Pub. No.: US 2009/0107437 A1
(43) Pub. Date: Apr. 30, 2009

(54) RF igniter having integral pre-combustion chamber

(75) Inventor: James M. Schultz, Chillicothe, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/980,592

(22) Filed: Oct. 31, 2007

(51) Int. Cl. F02P 15/00

(52) U.S. Cl. 123/143 B; 123/146.5 R

(57) ABSTRACT

An igniter for an internal combustion engine is disclosed. The igniter may have a base, and a cap fixedly connected to the base to form an integral pre-combustion chamber. The cap may have at least one orifice. The igniter may also have an electrode extending through the base and at least partially into the integral pre-combustion chamber. The electrode may be configured to direct current having a voltage component in the RF range into the integral pre-combustion chamber.

### TECHNICAL FIELD

The present disclosure is directed to a radio frequency (RF) igniter and, more particularly, to an RF igniter having an integral pre-combustion chamber.

### BACKGROUND

Engines, including diesel engines, gasoline engines, gaseous fuel powered engines, and other engines known in the art ignite injections of fuel to produce heat. In one example, fuel injected into a combustion chamber of the engine is ignited by way of a spark plug. The heat and expanding gases resulting from this combustion process may be directed to displace a piston or move a turbine blade, both of which can be connected to a crankshaft of the engine. As the piston is displaced or the turbine blade is moved, the crankshaft is caused to rotate. This rotation may be directly utilized to drive a device such as a transmission to propel a vehicle, or a generator to produce electrical power.

During operation of the engine described above, a complex mixture of air pollutants is produced as a byproduct of the combustion process. These air pollutants are composed of solid particulate matter and gaseous compounds including nitrous oxides (NOx). Due to increased attention on the environment, exhaust emission standards have become more stringent and the amount of solid particulate matter and gaseous compounds emitted to the atmosphere from an engine is regulated depending on the type of engine, size of engine, and/or class of engine.

One method that has been implemented by engine manufacturers to reduce the production of these pollutants is to introduce a lean air/fuel mixture into the combustion chambers of the engine. This lean mixture, when ignited, burns at a relatively low temperature. The lowered combustion temperature slows the chemical reaction of the combustion process, thereby decreasing the formation of regulated emission constituents. As emission regulations become stricter, leaner and leaner mixtures are being implemented.

Although successful at reducing emissions, very lean mixtures are difficult to ignite. That is, the single point arc from a conventional spark plug may be insufficient to initiate and/or maintain combustion of a mixture that has little fuel (compared to the amount of air present). As a result, the emission reduction available from a typical spark ignited engine operated in a lean mode may be limited. In addition, conventional spark plugs suffer from low component life due to the associated high temperature of the arc.

One attempt at improving combustion initiation of a lean mixture is described in U.S. Pat. No. 3,934,566 (the '566 patent) issued to Ward on Jan. 27, 1976. The '566 patent discloses a system for use with a controlled vortex combustion chamber (CVCC) engine having a main combustion chamber, a pre-combustion chamber, and one spark plug located in each of the combustion and pre-combustion chambers. The system couples high frequency electromagnetic energy (RF energy) into the pre-combustion chamber either through the associated spark plug or in the vicinity of the spark plug tip. The RF energy is produced by magnetrons or microwave solid-state devices, and can act in conjunction with the mechanically linked action of the typical distributor rotor shaft to obtain timing information therefrom. The system concentrates on using the RF energy to create a plasma mixture of air and fuel before, after, or before and after the instant the pre-combustion chamber is fired by means of an arc at the spark plug tip. The presence of the microwave energy at or near the spark plug tip modifies the voltage required for firing and facilitates ignition of a lean air/fuel mixture. It may even be possible to eliminate the arc altogether by using microwave sources in a pulsed mode and by designing the spark plug tip in such a manner that it both couples microwave energy efficiently to the air-fuel plasma mixture as a whole, as well as produces large electric fields at the highly localized region of the spark plug tip. The RF energy is coupled to the spark plug in the pre-combustion chamber, as compared to the combustion chamber, because the pre-combustion chamber contains an ignitable richer mixture.

Although the system of the '566 patent may improve combustion of a lean air/fuel mixture and, in one embodiment, may have an affect on the damage caused by high temperature arcing, the system may still be problematic and have limited applicability. For example, the amount of power and the voltage level required to produce a plasma of the air/fuel mixture and to ignite the mixture may be at least partially dependent on the volume of the mixture. That is, a large combustion chamber volume may require a large amount of power and high voltage levels to sufficiently ionize and ignite the air/fuel mixture within the chamber. Thus, although the system of the '566 patent may, in one embodiment, reduce the power requirement through the use of an engine's pre-combustion chamber, the required power and voltage levels may still be very high. And, in engines without pre-combustion chambers, the system of the '566 patent may require prohibitively large amounts of power and excessive voltage levels to ionize and ignite a lean air/fuel mixture within the larger combustion chambers.

The RF igniter of the present disclosure solves one or more of the problems set forth above.

### SUMMARY OF THE INVENTION

One aspect of the present disclosure is directed to an igniter. The igniter may include a base, and a cap fixedly connected to the base to form an integral pre-combustion chamber. The cap may have at least one orifice. The igniter may also include an electrode extending through the base and at least partially into the integral pre-combustion chamber. The electrode may be configured to direct current having a voltage component in the RF range into the integral pre-combustion chamber.

Another aspect of the present disclosure is directed to a method of operating an engine. The method may include generating a current having a voltage component in the RF range, and directing the current into a pre-combustion chamber separate from the engine to produce a corona. The method may also include directing a flame jet from the pre-combustion chamber into the engine.

### BRIEF DESCRIPTION OF THE DRAWINGS

FIG. 1 is a schematic and diagrammatic illustration of an exemplary disclosed power system; and

FIG. 2 is a cross-sectional illustration an exemplary disclosed igniter that may be used with the power system of FIG. 1.

### DETAILED DESCRIPTION

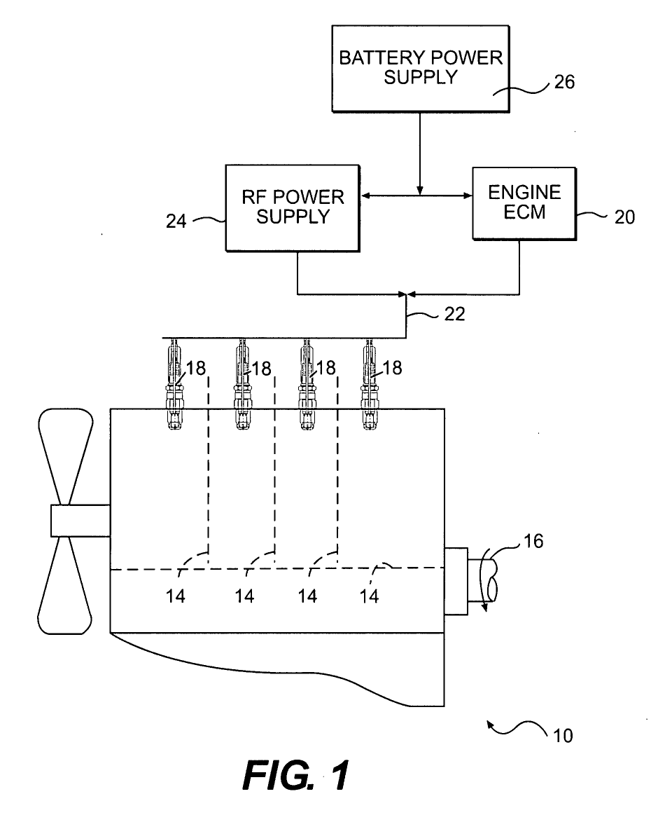

FIG. 1 illustrates a power system 10. Power system 10 may be any type of internal combustion engine such as, for example, a gasoline engine, a gaseous fuel-powered engine, or a diesel engine. Power system 10 may include an engine block 12 that at least partially defines a plurality of combustion chambers 14. In the illustrated embodiment, power system 10 includes four combustion chambers 14. However, it is contemplated that power system 10 may include a greater or lesser number of combustion chambers 14 and that combustion chambers 14 may be disposed in an “in-line” configuration, a “V” configuration, or any other suitable configuration.

As also shown in FIG. 1, power system 10 may include a crankshaft 16 that is rotatably disposed within engine block 12. A connecting rod (not shown) may connect a plurality of pistons (not shown) to crankshaft 16 so that a sliding motion of each piston within the respective combustion chamber 14 results in a rotation of crankshaft 16. Similarly, a rotation of crankshaft 16 may result in a sliding motion of the pistons.

An igniter 18 may be associated with each combustion chamber 14. Igniter 18 may facilitate ignition of fuel sprayed into combustion chamber 14 during an injection event, and may be timed to coincide with the movement of the piston. Specifically, the fuel within combustion chamber 14, or a mixture of air and fuel, may be ignited by a flame jet propagating from igniter 18 as the piston nears a top-dead-center position during a compression stroke, as the piston leaves the top-dead-center position during a power stroke, or at any other appropriate time.

To facilitate the appropriate ignition timing, igniter 18 may be in communication with and actuated by an engine control module (ECM) 20 via a power supply and communication harness 22. Based on various input received by ECM 20 including, among other things, engine speed, engine load, emissions production or output, engine temperature, engine fueling, and boost pressure, ECM 20 may direct a current from an RF power supply 24 to each igniter 18 via harness 22.

ECM 20 may include all the components required to run an application such as, for example, a memory, a secondary storage device, and a processor, such as a central processing unit. One skilled in the art will appreciate that the ECM 20 can contain additional or different components. ECM 20 may be dedicated to control of only igniters 18 or, alternatively, may readily embody a general machine or power system microprocessor capable of controlling numerous machine or power system functions. Associated with ECM 20 may be various other known circuits such as, for example, power supply circuitry, signal conditioning circuitry, and solenoid driver circuitry, among others.

A common source, for example an onboard battery power supply 26, may power one or both of RF power supply 24 and ECM 20. In typical vehicular applications, battery power supply 26 may provide 12 or 24 volt current. RF power supply 24 may receive the electrical current from battery power supply 26 and transform the current to an energy level usable by igniters 18 to ionize and ignite the air and fuel mixture within combustion chambers 14. For the purposes of this disclosure, high frequency energy or RF energy may be considered electromagnetic energy having a frequency in the range of about 50-2000 kHz and a voltage of up to about 50,000 volts or more. RF power supply 24 may transform the low voltage current from battery power supply 26 to RF energy through the use of magnetrons, microwave solid state devices, oscillators, and other devices known in the art.

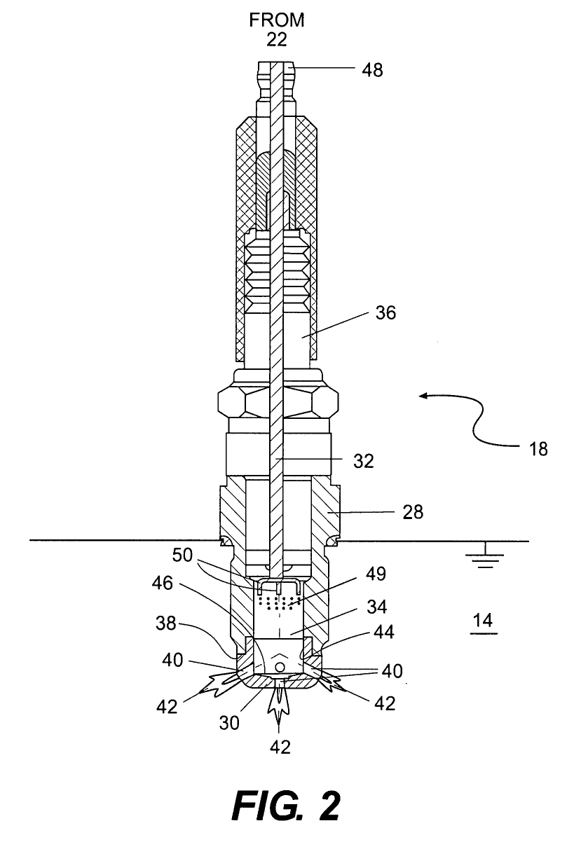

As illustrated in FIG. 2, igniter 18 may include multiple components that cooperate to ignite the air and fuel mixture within combustion chamber 14. In particular, igniter 18 may include a body 28, a cap 30, and at least one electrode 32. Body 28 may be generally hollow at one end and, together with cap 30, may at least partially form an integral pre-combustion chamber 34. Electrode 32 may extend from a terminal end 48 of igniter 18 through body 28 and at least partially into pre-combustion chamber 34. In one embodiment, an insulator 36 may be disposed between body 28 and electrode 32 to electrically isolate electrode 32 from body 28.

Body 28 may be a generally cylindrical structure fabricated from an electrically conductive material. In one embodiment, body 28 may include external threads 37 configured for direct engagement with engine block 12 or with a cylinder head (not shown) fastened to engine block 12 to cap off combustion chamber 14. In this configuration, body 28 may be electrically grounded via the connection with engine block 12 or the cylinder head.

Cap 30 may have a cup-like shape and be fixedly connected to an end 38 of body 28. Cap 30 may be welded, press-fitted, threadingly engaged, or otherwise fixedly connected to body 28. Cap 30 may include a plurality of orifices 40 that facilitate the flow of air and fuel into pre-combustion chamber 34 and the passage of flame jets 42 from pre-combustion chamber 34 into combustion chamber 14 of engine block 12. Orifices 40 may pass generally radially through an annular side wall 44 of cap 30 and/or through an end wall 46 of cap 30.

Electrode 32 may be fabricated from an electrically conductive metal such as, for example, tungsten, iridium, silver, platinum, and gold palladium, and be configured to direct current from RF power supply 24 to ionize (i.e., create a corona 49 within) and ignite the air and fuel mixture of pre-combustion chamber 34. In one embodiment, a plurality of prongs 50 may extend generally radially toward an internal wall of pre-combustion chamber 34, such that the current may be substantially distributed toward the internal wall.

### INDUSTRIAL APPLICABILITY

The igniter of the present disclosure may be applicable to any combustion-type power source. Although particularly applicable to low NOx engines operating on lean air and fuel mixtures, the igniter itself may be just as applicable to any combustion engine where component life of the igniter is a concern. The disclosed igniter may facilitate combustion of the lean air and fuel mixture by ionizing the mixture prior to and during ignition of the mixture. Component life may be improved by lowering the required ignition temperature through the use of a corona. And, by utilizing an integral pre-combustion chamber, the amount of energy required by the disclosed igniter for these processes may be low. The operation of power system 10 will now be described.

Referring to FIG. 1, air and fuel may be drawn into combustion chambers 14 of power system 10 for subsequent combustion. Specifically, fuel may be injected into combustion chambers 14 of power system 10, mixed with the air therein, and combusted by power system 10 to produce a mechanical work output and an exhaust flow of hot gases.

Referring to FIG. 2, as the injected fuel within combustion chambers 14 mixes with air, some of the mixture may enter pre-combustion chamber 34 of igniter 18 via orifices 40. At an appropriate timing relative to the motion of the pistons within combustion chambers 14, as detected or determined by ECM 20, ECM 20 may control RF power supply 24 to direct a current to igniters 18. The current, having voltage components in the RF energy range, may initially generate a corona at a tip of electrode 32 within pre-combustion chamber 34. As the energy builds within pre-combustion chamber 34, the ionized mixture of air and fuel may ignite. As the air and fuel mixture within pre-combustion chamber 34 ignites, flame jets 42 may propagate through orifices 40 into combustion chambers 14 of engine block 12, where the remaining air and fuel mixture may be efficiently combusted.

It will be apparent to those skilled in the art that various modifications and variations can be made to the igniter of the present disclosure without departing from the scope of the disclosure. Other embodiments will be apparent to those skilled in the art from consideration of the specification and practice of the igniter disclosed herein. It is intended that the specification and examples be considered as exemplary only, with a true scope of the disclosure being indicated by the following claims and their equivalents.

What is claimed is:

1. An igniter, comprising:
a base;
a cap fixedly connected to the base to form an integral pre-combustion chamber, the cap having at least one orifice; and
an electrode extending through the base and enclosed in the integral pre-combustion chamber, the electrode configured to direct current having a voltage component in the RF range into the integral pre-combustion chamber.

2. The igniter of claim 1, wherein the electrode includes a plurality of prongs extending radially toward an annular wall of the integral pre-combustion chamber.

3. The igniter of claim 1, wherein the at least one orifice includes a plurality of orifices extending through the cap.

4. The igniter of claim 1, wherein the current creates a corona within the integral pre-combustion chamber.

5. The igniter of claim 4, wherein the current ignites an air and fuel mixture within the integral pre-combustion chamber.

6. The igniter of claim 5, wherein the air and fuel mixture is lean.

7. The igniter of claim 5, wherein at least one flame jet resulting from ignition of the air and fuel mixture passes from the integral pre-combustion chamber through the at least one orifice.

8. The igniter of claim 4, wherein the current is distributed toward an annular wall of the integral pre-combustion chamber.

9. The igniter of claim 4, wherein an annular wall of the integral pre-combustion chamber is electrically grounded.

10. The igniter of claim 1, wherein the cap is welded to the base.

11. A method of operating an engine, comprising:
generating a current having a voltage component in the RF range;
directing the current into a pre-combustion chamber of an igniter to produce a corona; and
directing a flame jet from the pre-combustion chamber into the engine.

12. The method of claim 11, wherein the pre-combustion chamber engine is removably attachable to the engine.

13. The method of claim 11, wherein the air and fuel mixture is a lean mixture.

14. The method of claim 11, wherein the corona lowers an ignition temperature of an air and fuel mixture within the pre-combustion chamber.

15. The method of claim 14, wherein directing the current into the pre-combustion chamber ignites the air and fuel mixture.

16. The method of claim 11, wherein directing the flame jet includes directing the flame jet to ignite a lean air and fuel mixture within a main combustion chamber of the engine.

17. A power system, comprising:
an engine block at least partially defining a combustion chamber;
a power source configured to produce a current having a voltage component in the RE range; and
an igniter fluidly communicated with the combustion chamber and electrically communicated with the power source, the igniter including:
an integral pre-combustion chamber;
a plurality of orifices fluidly communicating the integral pre-combustion chamber with the combustion chamber of the engine block; and
an electrode enclosed within the integral pre-combustion chamber and being configured to direct the current into the integral pre-combustion chamber to create a corona.

18. The power system of claim 17, wherein the current ignites an air and fuel mixture within the integral pre-combustion chamber.

19. The power system of claim 18, wherein the air and fuel mixture is lean.

20. The power system of claim 18, wherein a plurality of flame jets resulting from ignition of the air and fuel mixture passes from the integral pre-combustion chamber through the plurality of orifices into the combustion chamber of the engine block.
